(19) United States
(12) Patent Application Publication
(10) Pub. No.: US 2026/0019283 A1
(43) Pub. Date: Jan. 15, 2026

(54) DEVICE MANAGEMENT SYSTEM, MANAGER, CONTROL METHOD FOR MANAGER, AND RECORDING MEDIUM

(71) Applicant: CANON KABUSHIKI KAISHA, Tokyo (JP)

(72) Inventor: TOSHIYUKI NAKAZAWA, Tokyo (JP)

(21) Appl. No.: 19/234,647

(22) Filed: Jun. 11, 2025

(30) Foreign Application Priority Data
Jul. 11, 2024 (JP) 2024-111668

(51) Int. Cl. H04L 9/32

(52) U.S. Cl. CPC H04L 9/3268

(57) ABSTRACT

In a device management system comprising a manager that manages a network device and an agent that relays communication between the manager and the network device, the manager comprises a setting unit that sets a verification setting indicating whether to perform verification of a certificate of the agent when performing encrypted communication with the agent; and a verification unit that performs verification of a certificate by determining whether to perform verification of the certificate of the agent when performing encrypted communication with the agent, based on a certificate registered in the manager and the verification setting, and the agent comprises a verification unit that performs verification of a certificate by determining whether to perform verification of the certificate of the manager when performing encrypted communication with the manager, based on a certificate registered in the agent.

### BACKGROUND

### FIELD OF THE TECHNOLOGY

The present disclosure relates to security in communication between a manager and an agent in a device management system.

### DESCRIPTION OF THE RELATED ART

There is a device management system that manages devices connected to a network. The device management system provides various services (functions) to the devices to be managed. In a case in which the number of devices to be managed is large, the device management system may be configured with a single manager that performs overall management and a plurality of agents that execute processing for the devices in accordance with instructions from the management apparatus. In communication with each device within the system, encryption of the communication is essential for ensuring security. In encrypted communication, certificate verification is performed to prevent impersonation of a e communication partner. Japanese Patent Application Laid-Open No. 2021-33645 discloses a multi-function printer (MFP) that, upon receiving a request for encrypted communication with an external server from an application that uses predetermined information, verifies the server certificate of the external server using a root certificate in which predetermined attribute information is set.

However, Japanese Patent Application Laid-Open No. 2021-33645 relates to communication between the MFP and a manager or an agent, which are management servers, and does not consider an agent that is installed between the MFP and the manager. To enhance the security of the system, there may be a need to perform certificate verification during communication between the manager and the agent as well.

### SUMMARY

The present disclosure enhances the security of communication in a device management system.

In a device management system comprising an apparatus that serves as a manager configured to manage a network device and an apparatus that serves as an agent configured to relay communication between the manager and the network device, the manager comprises a setting unit configured to set a verification setting indicating whether to perform verification of a certificate of the agent when performing encrypted communication with the agent; and a verification unit configured to perform verification of a certificate by determining whether or not to perform verification of the certificate of the agent when performing encrypted communication with the agent, based on a certificate registered in the manager and the verification setting, and acquiring a certificate from the agent if it has been determined that verification will be performed, wherein the agent comprises a verification unit configured to perform verification of a certificate by determining whether or not to perform verification of the certificate of the manager when performing encrypted communication with the manager, based on a certificate registered in the agent, and acquiring a certificate from the manager if it has been is determined that verification will be performed.

Features of the present disclosure will become apparent from the following description of embodiments with reference to the attached drawings. The following description of embodiments are described by way of example.

### BRIEF DESCRIPTION OF THE DRAWINGS

FIG. 1 is a diagram illustrating the configuration of a system.

FIG. 2 is a diagram illustrating a hardware configuration of an information processing apparatus on which a manager and an agent operate.

FIG. 3A is a diagram illustrating a software configuration of the manager.

FIG. 3B is a diagram illustrating a software configuration of the agent.

FIGS. 4A and 4B are diagrams illustrating an example of a certificate verification setting screen.

FIG. 5 is a flowchart illustrating a verification process performed by the manager.

FIG. 6 is a flowchart illustrating a verification process performed by the agent.

FIG. 7 is a flowchart illustrating a warning display process.

FIGS. 8A to 8C are diagrams illustrating respective examples of warning screens.

### DESCRIPTION OF THE EMBODIMENTS

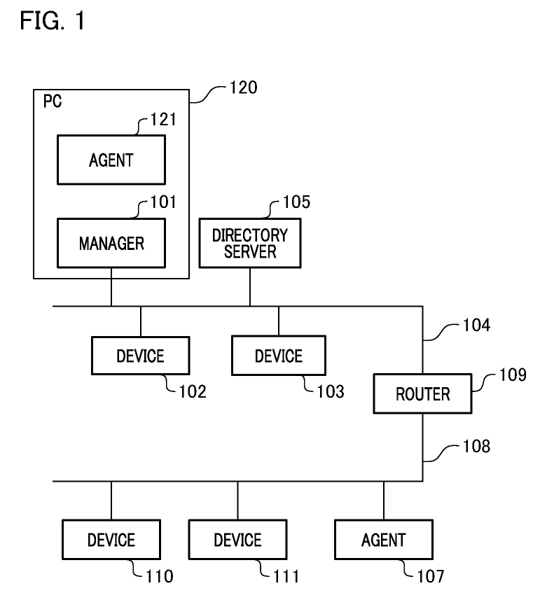

FIG. 1 is a diagram illustrating the configuration of a system. In a device management system, a manager that manages network devices (hereinafter, referred to as “devices”) provides services to the devices connected to the network via an agent. In a case in which the number of devices to be managed is large, the device management system is configured with an apparatus serving as a manager that performs overall management, and a plurality of apparatuses serving as agents that execute processing for the devices in accordance with instructions from the manager (a large-scale configuration). In contrast, in a case in which the number of devices to be managed is small, the manager and the agent are configured on the same host computer (apparatus) (a small-scale configuration).

In the example as shown in FIG. 1, the system includes a manager 101, a directory server 105, an agent 121, an agent 107, and a plurality of devices that are management targets (a device 102, a device 103, a device 110, and a device 111). The agent 121 operates on a PC 120, which is the same host computer (hereinafter referred to as a “host”) as the manager 101. In contrast, the agent 107 operates on a host that is different from the host on which the manager 101 operates.

The device 102, the device 103, the device 110, and the device 111 are network devices managed by the manager 101. Among them, the device 102 and the device 103 are connected to a network 104 to which an agent 121 is also connected. Communication between the manager 101, and the device 102 and the device 103 is performed via the agent 121. The device 110 and the device 111 are connected to a network 108 to which the agent 107 is also connected. Communication between the manager 101, and the device 110 and the device 111 is performed via a router 109 and the agent 107.

The device 102, the device 103, the device 110, and the device 111 are network devices managed by the manager 101. Among them, the device 102 and the device 103 are connected to a network 104 to which an agent 121 is also connected. Communication between the manager 101, and the device 102 and the device 103 is performed via the agent 121. The device 110 and the device 111 are connected to a network 108 to which the agent 107 is also connected. Communication between the manager 101, and the device 110 and the device 111 is performed via a router 109 and the agent 107.

The network 104 and the network 108 are connected by the router 109. The router 109 may be configured, for example, to permit communication between the manager 101 and the agent 107 on the network 108, while blocking communication between the manager 101, and the device 110 and the device 111. It should be noted that although, in the present embodiment, a large-scale configuration including two agents and four devices is used as an example for explanation, the configuration and operation are similar to those explained in the present embodiment even in a case in which tens of thousands of devices are managed via a dozen or more agents.

Although FIG. 1 illustrates an example in which both a case where the manager 101 and the agent operate on the same host and a case where they operate on different hosts coexist, the present disclosure is not limited thereto. For example, in a device management system with a large-scale configuration in which the number of devices to be managed is large, a plurality of agents is configured on hosts that are different from the host on which the manager 101 operates. In contrast, in a device management system with a small-scale configuration in which the number of devices to be managed is small, the manager 101 and the agent are configured on the same host, and no agent operates on a host that is different from the host on which the manager 101 operates. The system configuration of the present embodiment may be any one of: a configuration in which the agent operates on the same host on which the manager 101 operates; a configuration in which the agent operates on a host that is different from the host on which the manager 101 operates; or a configuration in which these configurations coexist.

The manager 101 provides various services (functions) for managing the network devices to be managed. The manager 101 has a device management application. When the manager 101 provides services to devices, it communicates with the devices using agents. The manager 101 incorporates, within the apparatus itself, a web service server related to the functions provided by the apparatus. Note that the manager 101 may be realized by a single information processing apparatus or a plurality of information processing apparatuses, a virtual machine using resources provided by a data center including an information processing apparatus (cloud service), or a combination thereof.

The agent 107 and the agent 121 perform device management processing based on instructions from the manager 101. Each of the agents 107 and 121 has an agent application. The agent 107 and the agent 121 incorporate a web service server related to the functions provided by the manager. Additionally, each of the agents 107 and 121 is associated with devices according to device addresses and the like. The agent 121 is associated with the device 102 and the device 103. The agent 107 is associated with the device 110 and the device 111.

The directory server 105 is an information processing apparatus that manages user information such as user accounts. The manager 101 and the directory server 105 are connected to each other via the network 104. The manager 101 can also be set so that a user of the directory server 105 can log in as a user of the manager 101. The directory server 105 may be realized by a single information processing apparatus or a plurality of information processing apparatuses, a virtual machine using resources provided by a data center including an information processing apparatus (cloud service), or a combination thereof.

The device 102, the device 103, the device 110, and the device 111 are network devices that are management targets of the manager 101 and can communicate with the manager 101 via their respective agents. The network device is, for example, a multi-function printer (MFP) that integrates multiple functions such as a printing function, a reading function, and a fax function. Note that the network device may be an information processing apparatus, such as a printer, a scanner, a 3D printer, or a PC; an image processing apparatus, such as a camera; a smart home appliance; and the like.

Here, the processing flow for providing services to a network device by the network device management system is explained using agent 121 and device 102 as an example. The manager 101 provides an instruction to the agent 121 to perform an operation on the device 102. The agent 121 communicates with the device 102 in accordance with an instruction from the manager 101, and performs an operation such as transmission of a request to the device 102. Then, the agent 121 transmits the result of the operation performed on the device 102 to the manager 101. Examples of operations performed on the device 102 by the agent 121 include acquiring information from the device 102, changing setting values of the device 102, instructing the installation of an application to the device 102, and instructing a firmware update of the device 102. Thus, communication is performed between the manager 101 and the agent 121, and between the agent 121 and the device 102. Therefore, the device 102 does not directly communicate with the manager 101.

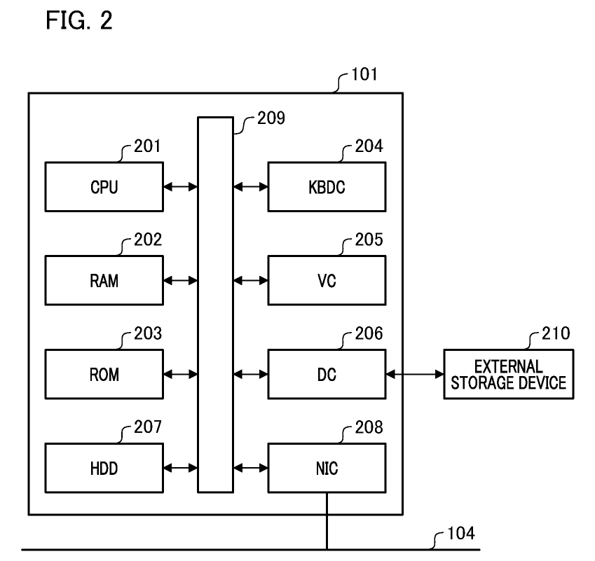

FIG. 2 is a diagram illustrating a hardware configuration of an information processing apparatus on which a manager and an agent are operated. In this context, the explanation is provided using the manager 101 as an example, while the host computer and the PC 120 on which the agent 121, the agent 107, and the directory server 105 operate have similar hardware configurations to the manager 101. The manager 101 is provided with a CPU 201, a RAM 202, a ROM 203, a KBDC 204, a VC 205, a DC 206, an HDD 207, and a NIC 208. These components are connected to a system bus 209.

The CPU 201 controls the entirety of the manager 101. The CPU 201 executes programs stored in a memory (ROM 203 or HDD 207) by loading them onto the RAM 202 as needed, and comprehensively controls each unit connected to the system bus 209. Additionally, the CPU 201 may comprehensively control each unit connected to the system bus 209 by loading software (programs) downloaded via a network onto the RAM 202 as needed, and executing these. The Random Access Memory (RAM) 202 is a memory capable of reading and writing data, and functions as the main memory of the CPU 201 or a work area. The Read Only Memory (ROM) 203 is memory for read-only data, and stores, for example, a basic control program for the manager 101. The hard disk drive (HDD) 207 stores various applications including a boot program, an operating system (OS), an authentication client, certificates, and data. An external storage device 210 is memory including a hard disk drive (HDD), a solid-state drive (SSD), and the like. The external storage device 210 stores various applications, database data, user files, and the like.

The KBDC 204 controls input to the manager 101. The KBDC 204 transmits input information from input devices such as a keyboard and a pointing device (not illustrated), or input by a virtual keyboard, by voice, and the like, to the CPU 201 and controls input to the manager 101. The VC 205 is a video controller that controls display on a display apparatus (not illustrated). The display device may be, for example, a Liquid Crystal Display (LCD) or a head-mounted display capable of Virtual Reality (VR) display. The DC 206 is a disk controller that controls access to the external storage device 210. The NIC 208 is a communication controller through which the manager 101 connects to the network 104. The CPU 201 enables data communication with each device on the network by connecting to the network 104 via the NIC 208.

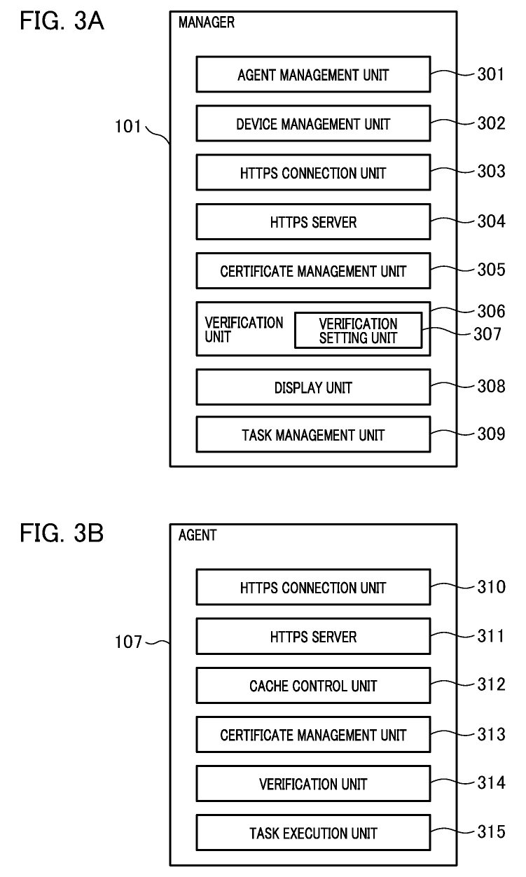

FIG. 3 is an explanatory view showing a software configuration of the device management server and the agent. FIG. 3A is an explanatory view showing a software configuration of the manager 101. The manager 101 realizes processing by the functional modules shown in FIG. 3A, by having the CPU 201 execute a device management application program that is accessed from a memory. The functional modules shown in FIG. 3A are, for example, provided as device management applications.

The manager 101 includes an agent management unit 301, a device management unit 302, an HTTPS connection unit 303, an HTTPS server 304, a certificate management unit 305, a verification unit 306, a display unit 308, and a task management unit 309. The agent management unit 301 manages information related to agents (the agent 121 and the agent 107) within the system. The device management unit 302 manages information related to devices to be managed (for example, the device 102, the device 103, the device 110, and the device 111). The information related to the devices includes information indicating which agent each device is associated with. The task management unit 309 performs task management. As this task management, the task management unit 309 manages the contents of operations performed on the device and their results. Additionally, the task management unit 309 instructs the agents to perform operations on the devices upon execution of tasks. The management information managed by the task management unit 309 is stored in a database (not illustrated).

The manager 101 and the agent 107 communicate with each other mainly using HTTPS. The HTTPS connection unit 303 is a connection source in HTTPS communication, and the HTTPS server 304 is a connection destination in HTTPS communication. The HTTPS connection unit 303 performs processing to connect to an external HTTPS server, such as an HTTPS server 311 of the agent 107. The HTTPS server 304 is a web service server incorporated into the manager 101, and is related to services provided by the manager 101. The HTTPS server 304 receives requests from external devices such as agents and devices and returns responses to these requests. The HTTPS server 304 also provides a WEB UI for the user to operate the manager 101.

The certificate management unit 305 performs management of certificates used when encrypted communication is performed. Certificates are used for authenticating the connection destination and ensuring data integrity. The certificate management unit 305 manages certificates set for the HTTPS server of the manager 101. As an initial setting, a self-signed certificate is registered in the manager 101. The user can replace the self-signed certificate with a certificate digitally signed by an intermediate Certificate Authority (CA) (hereinafter, referred to as a “server certificate”). The certificate management unit 305 accepts user registration of a new server certificate (import). Therefore, as a certificate, either a self-signed certificate or a server certificate is registered in the manager 101. The certificates registered in the manager 101 are stored in the HDD 207.

Additionally, the certificate management unit 305 performs management of certificate information that has been acquired from agents. There are a plurality of timings when the manager 101 acquires certificates from agents. For example, when the manager 101 establishes an HTTPS connection with the agent, it sends a request to the agent to acquire a certificate and acquires the certificate. Additionally, when a new certificate is registered in the agent, the agent immediately transmits the registered certificate to the manager 101, and the manager 101 acquires the transmitted certificate. Additionally, the agent sends the certificate to the manager 101 at a predefined regular interval, and the manager 101 acquires the transmitted certificate. The certificate management unit 305 manages the latest certificate acquired from each agent.

The verification unit 306 performs certificate verification. In the present embodiment, the verification unit 306 verifies whether or not the certificate acquired from the agent has been digitally signed by the intermediate certificate authority (CA). The server certificate contains a public key described therein. As the method for verifying the certificate, a standard processing method of the OS is used. Verification of a certificate is performed in accordance with the Public Key infrastructure (PKI) standard, based on standards such as RFC 5280. Additionally, a certificate specified by the user can be added to the certificate list in the OS, and a certificate added to the list can also be treated as a trusted certificate. Note that the method for verifying the certificate is not limited thereto.

The verification unit 306 includes a verification setting unit 307 that sets a verification setting as to whether or not to perform certificate verification for the agent when performing encrypted communication. The verification setting unit 307 provides a setting screen for performing verification settings, receives user instructions to enable/disable the verification settings, and stores the settings. Additionally, the verification unit 306 determines whether to perform certificate verification for the agent when performing encrypted communication with the agent. The verification unit 306 of the manager 101 determines whether or not to perform verification based on the certificate registered in the manager 101 and the verification settings set by the user.

The display unit 308 controls display of a screen provided by the manager 101. In the present embodiment, the display unit 308 displays a certificate verification setting screen provided by the verification unit 306 and a warning display screen provided by the certificate management unit 305. The display unit 308 may display a screen on a display device (not illustrated) by controlling the VC 205, or may display a screen on a web browser.

FIG. 3B is an explanatory view showing the software configuration of the agent. Although in this context, the agent 107 is explained as an example, the other agent 121 also has the same configuration. The agent 107 realizes processing by functional modules shown in FIG. 3B by having the CPU 201 execute a device management agent application program accessed from a memory. The functional modules shown in FIG. 3B relate to services provided by the manager 101 and are provided, for example, as an agent application provided by the manager 101.

The agent 107 includes an HTTPS connection unit 310, the HTTPS server 311, a cache control unit 312, a certificate management unit 313, a verification unit 314, and a task execution unit 315. The task execution unit 315 executes tasks instructed by the manager 101. After executing operations on devices in accordance with instructions from the manager 101, the task execution unit 315 transmits the results to the manager 101.

The manager 101 and the agent 107 communicate with each other mainly using HTTPS. The HTTPS connection unit 310 is a connection source in HTTPS communication, and the HTTPS server 311 is a connection destination in HTTPS communication. The HTTPS connection unit 310 performs processing to connect to external HTTPS servers such as the HTTPS server 304 of the manager 101. The HTTPS server 311 is a web service server that is incorporated into the agent 107, and is related to services provided by the agent 107. The HTTPS server 311 receives requests from external devices such as the agent 101 and devices and returns responses to these requests. The cache control unit 312 provides a cache function for content within the manager 101. Static content such as data for firmware updates can be temporarily stored as a cache in the agent 107 for a fixed period of time. Accordingly, if the same static content is requested by different devices, the agent 107 transmits the temporarily cached contents to the requesting device, thereby providing the content more quickly. Additionally, by utilizing the cache, communication between the manager 101 and the agent 107 can be reduced, thereby lowering the load on the manager 101.

The certificate management unit 313 manages the certificates that are used when performing encrypted communication. The certificate management unit 305 manages the certificates that are set for the HTTPS server of the agent 107. As an initial setting, a self-signed certificate is registered in the agent 107. The user can replace the self-signed certificate with a server certificate digitally signed by an intermediate certificate authority (CA). The certificate management unit 313 accepts user registration of a new server certificate (import). Therefore, either a self-signed certificate or a server certificate is registered in the agent 107 as a certificate,. Certificates registered in the agent 107 are stored in the HDD 207 of the agent 107. Upon receiving a certificate acquisition request from the manager 101, the certificate management unit 313 transmits the certificate to the manager 101. Additionally, in a case in which a new certificate is registered in the agent 107, the certificate management unit 313 transmits the certificate to the manager 101. Additionally, in a case in which periodic transmission of certificates to the manager 101 is specified, the certificate management unit 313 transmits the certificate to the manager 101 at predetermined regular timing.

It should be noted that, in general, replacement of a self-signed certificate with a server certificate is first performed for the manager 101, which manages the entire system. Thereafter, replacement with a server certificate is also performed for the agent 107, as needed. Accordingly, in the present embodiment, in a case in which a server certificate has been registered in the agent 107, it is treated as if this server certificate has been registered in the manager 101 as well. Additionally, in a case in which a server certificate has not been registered in the manager 101, it is treated as if no server certificate has been registered in the agent 107 as well.

The verification unit 314 performs certificate verification. In the present embodiment, the verification unit 314 verifies whether or not the certificate acquired from the manager 101 has been digitally signed by an intermediate certification authority (CA). The server certificate contains a public key described therein. The method of certificate verification performed by the verification unit 314 is the same as the method of certificate verification performed by the verification unit 306 of the manager 101. Additionally, the verification unit 314 determines whether or not to perform certificate verification for the manager 101 when performing encrypted communication with the manager 101. The verification unit 314 of the agent determines whether or not to perform verification based on the certificate that is registered on the agent itself.

When performing encrypted communication using an HTTPS server, a certificate is necessary. In the HTTPS servers of the manager 101 and each agent (the agent 107 and the agent 121), a self-signed certificate is set after installation as a digital certificate used for encrypted communication. A self-signed certificate is a certificate in which the certificate issuance destination and the certificate issuance are the same, and in general, a self-signed certificate is less reliable than a certificate issued by a certificate authority, and a self-signed certificate is determined to be invalid in certificate verification. The user can replace the self-signed certificate of the HTTPS server with a valid server certificate issued by a user-provided certification authority, which has higher reliability. In the present embodiment, it is assumed that certificate replacement is performed either for both the manager 101 and the agent, or for the manager 101 alone. In contrast, in the present embodiment, it is not assumed that only the certificate of the agent, which executes instructions from the manager 101, is replaced without replacing the certificate of the manager 101, which manages the entire system.

The HTTPS server performs encrypted communication using Hypertext Transfer Protocol Secure (https). HTTPS encrypts communication using Secure Sockets Layer (SSL)/Transport Layer Security (TLS) and establishes a secure connection for HTTPS communication. In HTTPS communication, encryption of communication is performed using a key, and server verification (authentication) is carried out using a certificate. The encryption protects the communication content from being wiretapped or tampered with by a malicious third party. Additionally, it is possible to prevent impersonation by a malicious third party by confirming the communication partner through server verification (authentication) using a certificate.

In server verification using certificates, whether or not the server certificate transmitted from the connection destination has been digitally signed by an intermediate certification authority (CA) is verified. The verification procedure is executed according to the PKI standard. For example, in a case in which the manager 101, which is the connection source, performs encrypted communication with the agent 107, which is the connection destination, the manager 101 verifies the certificate of the agent 107. In contrast, in a case in which the agent 107, which is the connection source, performs encrypted communication with the manager 101, which is the connection destination, the agent 107 verifies the certificate of the manager 101.

Note that, in a case in which the manager and the agent operate on the same host, there is no risk of the communication being monitored by a third party or of the connection destination being impersonated, and therefore, certificate verification is not necessary. Therefore, in a case in which the manager and the agent operate on the same host, as in the case of the manager 101 and the agent 121, the manager 101 does not perform certificate verification for the agent 121. Similarly, in a case in which the manager and the agent operate on the same host, the agent 121 also does not perform certificate verification for the manager 101.

In the present embodiment, the manager 101 is configured to allow whether or not server certificate verification is to be executed to be set. In a case in which a setting to execute server certificate verification is made, the manager 101 performs server certificate verification for the agent in a case of connecting to the HTTPS server of the agent. In contrast, in a case in which the risk of impersonation is low due to the network configuration and the like, it is also possible to make a setting not to execute server certificate verification, and in a case in which a setting to not execute server certificate verification is made, the manager 101 does not perform server certificate verification for the agent.

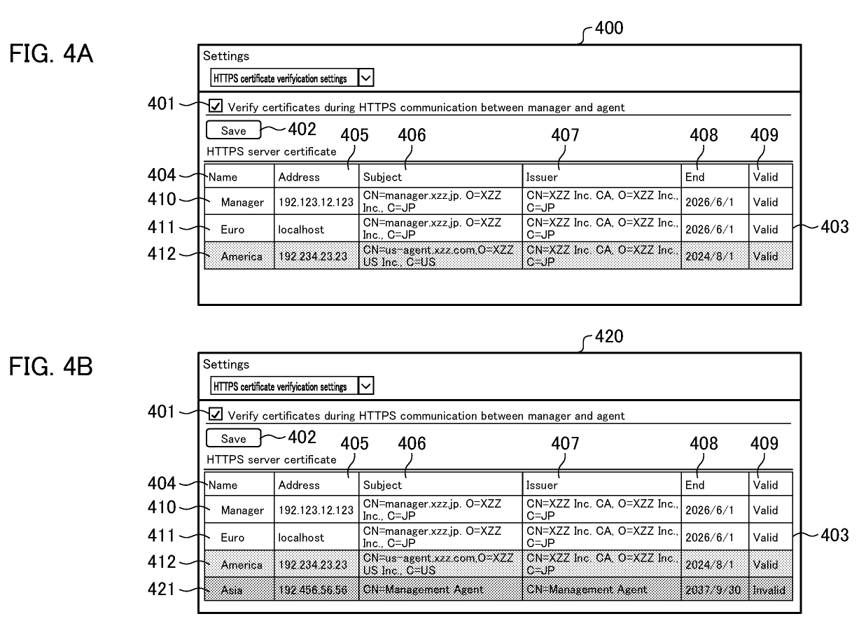

FIG. 4 is a diagram illustrating an example of a server certificate verification settings screen. A server certificate verification settings screen 400 is a screen that is provided by the manager 101. In a case in which a user who is logged into the service provided by the device management system has authority to perform certificate verification settings, a verification settings screen 400 is displayed. The verification settings screen 400 is a screen provided by the verification setting unit 307 of the verification unit 306 of the manager 101, with its display controlled by the display unit 308.

In the verification setting screen 400, a check mark 401 for setting the presence or absence of verification, a save button 402, and a certificate list 403 of the HTTPS servers of the manager and the agent(s) are displayed. In a case in which the user sets the performance of server certificate verification, the user checks the check mark 401, and in a case in which the user sets the omission of server certificate verification, the user unchecks the check mark 401. Then, when the save button 402 is pressed, the verification setting unit 307 saves the setting for enabling/disabling verification according to the current state of the check mark 401.

In the present embodiment, the server certificate verification settings can be changed to enabled only in a case in which all the certificates in the certificate list 403 are valid. That is, the user can check the check mark 401 only in a case in which all the certificates in the certificate list 403 are valid. On the certificate list 403, a certificate 410 of the manager and the certificates of each agent are displayed. Items displayed for each certificate include, for example, a name 404, an address 405, a subject 406, an issuer 407, a validity period 408, and a valid/invalid 409.

The name 404 is either the name of the manager corresponding to the certificate or the name of the agent that was set by the user. The address 405 is the address of the HTTPS server. A Euro server 411, which is an agent, shares the same host with the manager 101 and uses the same server certificate. The subject 406 is information on the owner of the certificate to be certified by the certificate. “CN” indicates the Common Name, “O” indicates the Organization, and “C” indicates the Country. Note that, in the case of a self-signed certificate, “Management Agent” is displayed as the CN in the subject 406. The issuer 407 is information about an issuer that issued the certificate. “CN” indicates the Common Name, “O” indicates the Organization, and “C” indicates the Country. Note that in the case of a certificate issued by the certification authority, the name of the certification authority that issued the certificate is displayed as the CN of the issuer 407, and in the case of a self-signed certificate, “Management Agent” is displayed as the CN of the issuer 407.

The validity period 408 indicates the validity period of the certificate. In the certificate list 403, if the end of the validity period of a valid certificate is closer than a predetermined period (for example, if the end of the validity period will be reached within one month), a warning is displayed. The warning display may be performed, for example, by changing the background color of the certificate row to a color such as yellow or by displaying an icon. In the example shown in FIG. 4A, the certificate of an American server 412, which is an agent, is valid. However, since the end of the validity period of the certificate is approaching, the background color is changed to light gray. On the other hand, a warning display is not performed for the manager 101 and the Euro server 411, as their certificates have longer remaining validity periods.

The valid/invalid 409 indicates whether or not the certificate is valid. If the certificate replaced by the user is valid, “Valid” is displayed, and if the certificate is a self-signed certificate or if the certificate replaced by the user is invalid, “Invalid” is displayed. The certificates that are shown in FIG. 4A are all valid. In contrast, in the certificates shown in FIG. 4B, the certificate for the Asia server 421, which is an agent, is a self-signed certificate and is displayed as invalid. In a case in which the valid/invalid 409 is “Invalid,” a warning display is performed. The warning display may be performed, for example, by changing the background color of the certificate row to a color such as red or by displaying an icon. In the verification setting screen 420, as shown in FIG. 4B, the certificate of the Asia server 421 is a self-signed certificate and is invalid, so the background color is changed to dark gray.

In the present embodiment, the check mark 401 can only be selected if all of the certificates that are listed in the certificate list 403 are valid. If there is an invalid certificate, the check mark 401 can be unchecked, but it cannot be checked. Accordingly, the certificates shown in the verification setting screen 400 in FIG. 4A are all valid, and in this state, the user can check the check mark 401. In contrast, the verification setting screen 420 in FIG. 4B shows the state in which verification was enabled (the check mark 401 is checked) before the certificate for the Asia server 421 was added, and after verification is enabled, the self-signed certificate for the Asia server 421 is added. In a case in which an invalid certificate exists as shown in FIG. 4B, the check mark 401 can be unchecked; however, once it is unchecked, it cannot be checked again.

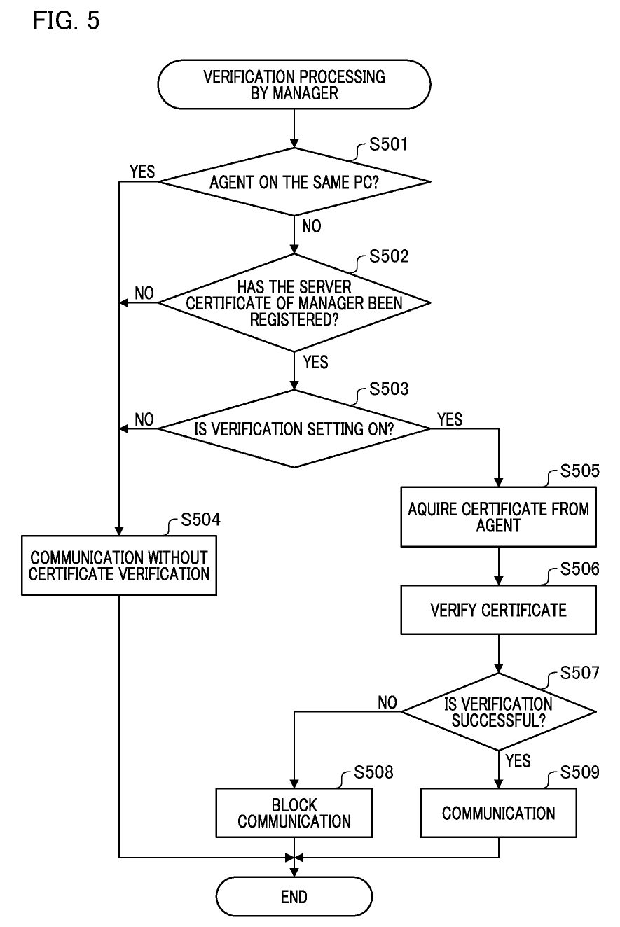

Next, an explanation will be given of the processing for determining whether or not to perform certificate verification when communication is established between the manager 101 and the agent, and for verifying the certificate if verification is to be performed. This will be explained for both the case in which the manager 101 is the connection source and the case in which e the agent is the connection source. First, an explanation will be given of the processing for verifying the certificate of the HTTPS server 311 of the agent when the manager 101, which is the connection source, connects to the agent, which is the connection destination. FIG. 5 is a flowchart illustrating certificate verification processing performed by the manager. Each processing shown in FIG. 5 is realized by having the CPU 201 of the manager 101 execute a program accessed from a memory (ROM 203, HDD 207, or an external storage device 210). This processing is executed when the manager connects to the agent to perform HTTPS communication.

In steps S501 to S503, the verification unit 306 of the manager determines whether or not to perform certificate verification. First, in S501, the verification unit 306 determines whether or not the agent, which is a connection destination, operates on the same host as the manager. For example, in a case in which the manager and the agent operate on the same PC, as in the case of the manager 101 and the agent 121, the verification unit 306 of the manager 101 determines that the agent, which is a connection destination, operates on the same host. Conversely, if the manager and the agent 107 do not operate on the same host, as in the case of the manager 101 and the agent 107, the verification unit 306 of the manager 101 determines that the agent, which is the connection destination, operates on a different host. If the agent, which is the connection destination, operates on the same host, there is no risk of an adversary-in-the-middle attack on the communication between the manager and the agent, and therefore, certificate verification is unnecessary. If the agent, which is the connection destination, operates on the same host as the manager, the processing in step S504 is performed. In contrast, if the agent, which is the connection destination, operates on a different host, the processing of step S502 is performed.

In S502, the verification unit 306 determines whether or not a server certificate has been registered for the manager. The server certificate is a certificate that has been digitally signed by an intermediate Certification Authority (CA) with which the user has replaced a self-signed certificate. If the self-signed certificate of the manager has not been replaced with a server certificate, it can be considered that replacing the self-signed certificate with a server certificate has not also been performed for an agent functioning as a relay apparatus that relays instructions from the manager. Therefore, in the present embodiment, in a case in which the server certificate has not been registered for the manager by the user, it is treated as if the server certificate has not been registered for the agent as well. Accordingly, in a case in which a server certificate has not been registered in the manager, the server certificate to be verified is not registered in the agent either. Therefore, verification of the server certificate for the agent is not necessary. In a case in which a server certificate has been registered for the manager, the processing in S503 is performed. In contrast, in a case in which the server certificate has not been registered for the manager, including cases in which the certificate is a self-signed certificate, the processing in step 504 is performed.

In S503, the verification unit 306 determines whether or not the setting for performing certificate verification is enabled (ON). The verification setting is set by the user on the verification setting screen 400, and the verification setting unit 307 stores this setting. In the present embodiment, the certificate verification is performed only if the user has enabled the setting for performing certificate verification. In a case in which the setting for performing certificate verification is enabled, the processing of S505 is executed. On the other hand, in a case in which the setting for performing certificate verification is disabled, the processing of S504 is performed.

In S504, the HTTPS connection unit 303 communicates with the agent without performing server certificate verification for the agent. The HTTPS connection unit 303 performs a TLS handshake process that omits server certificate verification for the agent and starts secure encrypted communication with the agent. Specifically, the verification unit 306 generates a handler that omits server certificate verification for the agent and provides the handler to the HTTPS connection unit 303. The HTTPS connection unit 303 creates an HTTP client by specifying the created handler and transmits a request to the agent by using the created HTTP client. Subsequently, the HTTPS connection unit 303 receives a response to the request from the agent and continues the communication. As described above, in the present embodiment, server certificate verification for the agent is not performed in any of the following cases: in a case in which the manager and the agent operate on the same host, in a case in which the server certificate of the manager has not been registered, or in a case in which the certificate verification setting is disabled.

In steps S505 to S509, the verification unit 306 and the HTTPS connection unit 303 perform a TLS communication handshake process for performing certificate verification, and, if verification is successful, secure encrypted communication with the agent is initiated, whereas, if verification fails, the communication is blocked. First, in step S505, the HTTPS connection unit 303 obtains the certificate from the agent serving as the connection destination. Specifically, the verification unit 306 creates a handler that performs server certificate verification for the agent and provides the created handler to the HTTPS connection unit 303. The HTTPS connection unit 303 creates an HTTP client by specifying the created handler, and transmits a request to the agent by using the created HTTP client. Subsequently, the HTTPS connection unit 303 receives a response to the request from the agent. The response from the agent includes a certificate for the agent.

In S506, the verification unit 306 performs verification for the certificate that was obtained from the agent. The verification unit 306 verifies whether or not the certificate obtained from the agent has been digitally signed by an intermediate certificate authority (CA). Certificate verification is performed in accordance with, for example, PKI standards. In step S507, it is determined whether or not the certificate verification in step S506 is successful. If the certificate verification was successful, the processing in S509 is performed. On the other hand, if the certificate verification was not successful, the processing in step S508 is performed. For example, in cases in which the certificate is a self-signed certificate or a server certificate with an expired validity period, the certificate verification fails.

In step S508, the HTTPS connection unit 303 blocks the communication with the agent. If the certificate verification was not successful, there is a possibility that the communication partner is an impersonator, and secure communication cannot be established, and therefore, the communication is blocked. In step S509, the HTTPS connection unit 303 initiates secure encrypted communication with the agent for which a successfully verified certificate has been registered. As a result, certificate verification becomes possible in a case in which a self-signed certificate for an agent operating on a host that is different from the host on which the manager operates has been replaced with a server certificate, and the user selects the setting to perform certificate verification.

As described above, in the present embodiment, certificate verification for the agent operating on a different host than the manager is performed in a case in which a server certificate has been registered for the manager and the verification setting is set to on. By performing certificate verification, communication security can be enhanced. In contrast, server certificate verification for the agent is not performed in any of the following cases: in a case in which the manager and the agent operate on the same host, in a case in which the server certificate of the manager has not been registered, or in a case in which the certificate verification setting is disabled.

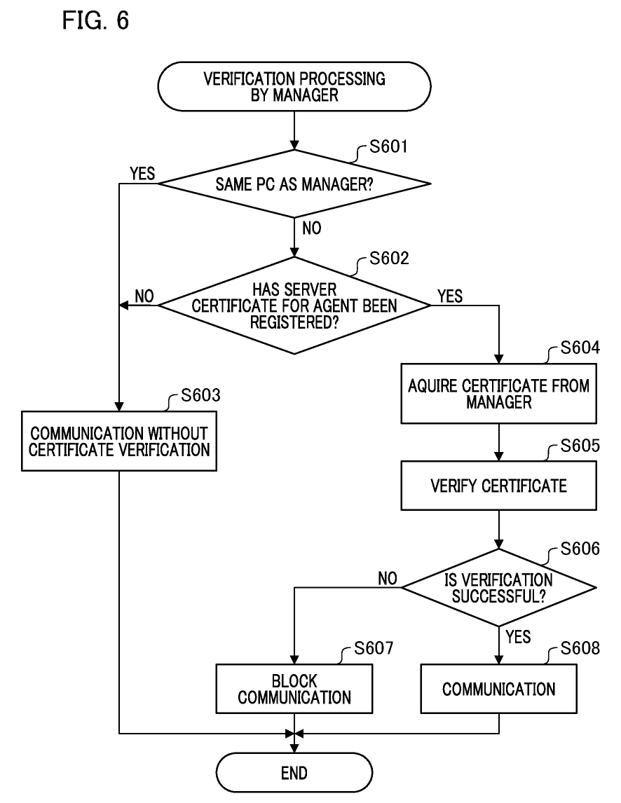

Next, an explanation will be given of the processing for performing certificate verification for the HTTPS server 304 of the manager 101 when the agent, which is the connection source, connects to the manager 101, which is the connection destination. FIG. 6 is a flowchart illustrating certificate verification processing performed by the agent. Each process shown in FIG. 6 is realized by having the CPU 201 of the manager 101 execute a program accessed from a memory (ROM 203, HDD 207, or external storage device 210). This process is executed when an agent establishes a connection to the manager in order to perform HTTPS communication.

In step S601 and step S602, the verification unit 314 of the agent determines whether or not to perform certificate verification. First, in step S601, the verification unit 314 determines whether or not the manager, which is the connection destination, operates on the same host as the agent. In a case in which the manager, which is the connection destination, operates on the same host, there is no risk of an adversary-in-the-middle attack on the communication between the agent and the manager, and therefore, certificate verification does not need to be performed. In a case in which the manager, which is the connection destination, operates on the same host, the processing in step S603 is performed. In contrast, in a case in which the manager, which is the connection destination, operates on a host that is different from the host on which the agent operates, the processing in step S602 is performed. For example, in a case in which the agent 121 connects to the manager 101, since the agent 121 and the manager 101 operate on the same host, certificate verification is not performed. In contrast, in a case in which the agent 107 connects to the manager 101, since the agent 107 and the manager 101 operate on different hosts, certificate verification is required if a server certificate has been registered for the manager 101.

In S602, the verification unit 314 determines whether or not a server certificate for the agent has been registered. The server certificate is a certificate that has been digitally signed by an intermediate Certification Authority (CA) and that the user uses to replace a self-signed certificate. In a case in which the replacement of a self-signed certificate with a server certificate has been performed in an agent that functions as a relay apparatus that relays instructions from the manager, it is assumed that replacement of the self-signed certificate with the server certificate has also been performed for the manager in advance. Additionally, although the setting for whether or not to perform certificate verification is set on the manager side, it is difficult for the agent side to securely obtain the verification setting that was set in the manager. Therefore, regardless of the verification setting, the necessity of verification is determined based on the presence/absence of a certificate on the agent side. Therefore, in the present embodiment, in a case in which a server certificate has been registered in the agent by the user, it is highly likely that a server certificate has been registered in the manager as well, and it is treated as if verification of the server certificate should be performed. In a case in which a server certificate for the agent has been registered, the process in step S604 is performed. In contrast, in a case in which a server certificate for the agent has not been registered, it is treated as if server certificate verification should not be performed. If a server certificate for the agent has not been registered, the processing in step S603 is performed.

In S603, the HTTPS connection unit 310 performs communication with the manager without performing server certificate verification for the manager. The HTTPS connection unit 310 performs a TLS handshake process that omits server certificate verification for the manager and initiates secure encrypted communication with the manager. Specifically, the verification unit 314 creates a handler that omits server certificate verification for the manager and provides the created handler to the HTTPS connection unit 310. The HTTPS connection unit 310 creates an HTTP client by specifying the created handler and transmits a request to the manager by using the created HTTP client. Subsequently, the HTTPS connection unit 310 receives a response to the request from the manager and continues the communication. As described above, in the present embodiment, communication is performed without performing server certificate verification for the manager in any of the following cases: in a case in which the agent and the manager operate on the same host, or in a case in which the server certificate for the agent has not been registered.

In steps S604 to S608, the verification unit 314 and the HTTPS connection unit 310 perform a TLS handshake process that verifies the certificate. If the verification is successful, secure encrypted communication with the manager starts. If the verification is not successful, communication is blocked. First, in step S604, the HTTPS connection unit 310 transmits a request including a certificate acquisition request to the manager, which is the connection destination, and acquires the certificate of the manager as a response. Specifically, the verification unit 314 creates a handler for performing server certificate verification for the agent, and passes the created handler to the HTTPS connection unit 310. The HTTPS connection unit 310 creates an HTTP client by specifying the created handler, and transmits a request to the manager by using the created HTTP client. Then, the HTTPS connection unit 310 receives a response to the request from the manager. The response from the manager includes the certificate of the manager.

In step S605, the verification unit 314 performs verification on the certificate that has been obtained from the manager. The verification unit 314 verifies whether or not the certificate obtained from the manager has been digitally signed by an intermediate Certification Authority (CA). Certificate verification is performed in accordance with, for example, PKI standards. In step S606, it is determined whether or not the certificate verification in step S605 was successful. If certificate verification was successful, the processing in S608 is performed. In contrast, if the certificate verification was not successful, the processing in S607 is performed. For example, in cases in which the certificate is a self-signed certificate or a server certificate with an expired validity period, the certificate verification fails.

In step S607, the HTTPS connection unit 310 blocks the communication with the manager. If certificate verification is not successful, there is a possibility that the communication partner is an impersonator, and secure communication cannot be established, and therefore, the communication is blocked. In step S608, the HTTPS connection unit 310 initiates secure encrypted communication with the manager, for which a successfully verified certificate has been registered. As a result, in a case in which the self-signed certificate of the manager, which is operating on a host that is different from the host on which the agent operates, has been replaced with a server certificate, certificate verification is performed, thereby enhancing the security of the communication.

As described above, in the present embodiment, certificate verification for a manager operating on a host that is different from a host on which the agent operates is executed in a case in which a server certificate has been registered for the agent. By performing certificate verification, communication security can be enhanced. In contrast, server certificate verification for the manager is omitted in any of the following cases: in a case in which the manager and the agent operate on the same host, or in a case in which the server certificate for the agent has not been registered.

Even after registering the server certificates in the manager 101 and the agent, the validity of the certificate is confirmed in the manager 101 so that security is further enhanced, and a warning display related to the certificate is performed. In the present embodiment, as was explained with reference to FIG. 4, it is possible to set a verification setting for performing certificate verification. In a case in which an agent that is operating on a host that is different from the host on which the manager 101 operates is present, and the verification setting is set to off (disabled), a warning screen prompting the user to set the verification setting to on (enabled) is displayed. By enabling the verification setting, it is possible to perform certificate verification when the manager 101 connects to an agent that does not operate on the same host, thereby improving the security of communication. Furthermore, in a case in which the verification setting is enabled and there exists an invalid certificate or a certificate for which the validity period is approaching, a warning screen prompting the update of the certificate is displayed. By causing a valid certificate to be registered, it is possible to enhance the security of communication. The warning screen displayed by the warning display process is a screen provided by the certificate management unit 305 of the manager 101 and is displayed under the control of the display unit 308. It should be noted that the presence/absence of execution of the warning display process may be set by the user, or the warning display process may be executed each time a specified user logs in after the self-signed certificate of the manager 101 has been replaced with a server certificate.

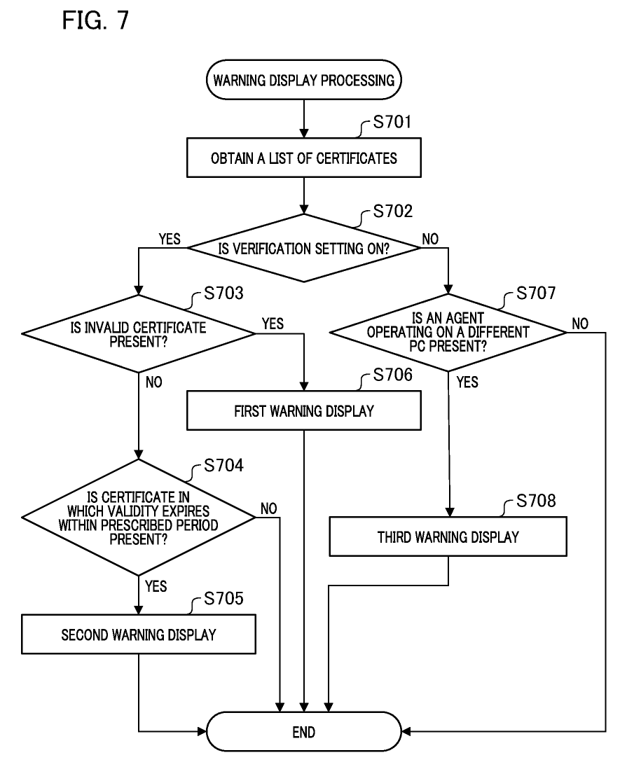

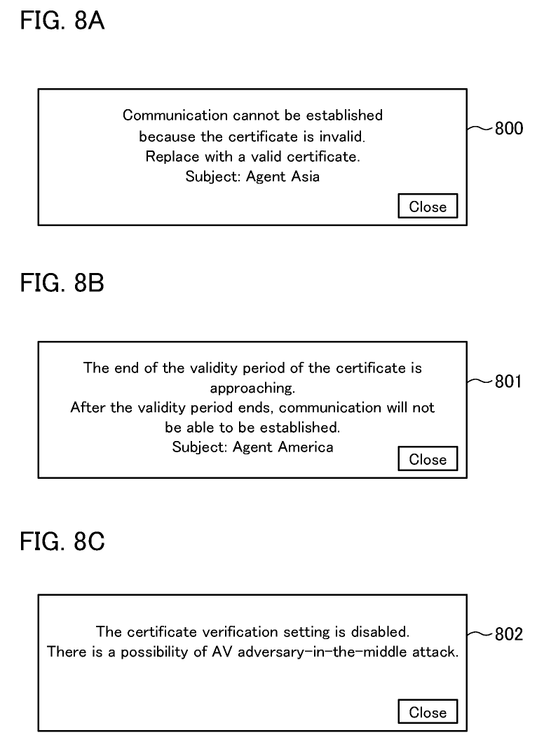

The process of performing a warning display related to a certificate in the manager 101 will be explained with reference to FIG. 7 and FIG. 8. FIG. 7 is a flowchart illustrating a warning display process. Each process shown in FIG. 7 is realized by having the CPU 201 of the manager 101 execute a program accessed from a memory (ROM 203, HDD 207, or external storage device 210). FIG. 8 is a diagram showing an example of the warning screen. The warning display processing is executed when a user with the authority to set certificate verification settings logs into a service provided by the device management system.

In step S701, the certificate management unit 305 obtains information regarding the list of certificates under management. The information regarding the list of certificates includes information regarding the certificate of the manager 101 and the certificate for the agent. As certificate information, information similar to the information displayed in the certificate list 403 in FIG. 4 may be acquired, or only the validity/invalidity and validity period of each certificate may be acquired.

In step S702, the certificate management unit 305 determines whether or not the certificate verification setting managed by the verification unit 306 is on (enabled) or not. In a case in which the certificate verification setting is set to on, the processing in step S703 is performed. On the other hand, in a case in which the certificate verification setting is set to off, the processing in step S707 is performed.

As was explained in the certificate verification settings screen 400, the certificate verification setting can be changed from off to on only when all of the certificates that are managed by the certificate management unit 305 are valid. However, various factors, such as the validity period for a certificate expiring after the verification setting has been set to on, may cause the certificates that are managed by the certificate management unit 305 to become invalid. In step S703, the certificate management unit 305 confirms whether or not there are any invalid certificates among the certificates that are managed by the manager 101 and the certificates of the agents that are under management. If any invalid certificates are present, the processing in step S706 is performed. On the other hand, if all of the certificates are valid and there are no invalid certificates, the processing in step S704 is performed.

In step S706, the display unit 308 displays a first warning screen provided by the certificate management unit 305. FIG. 8A is a diagram illustrating an example of the first warning screen. On a first warning screen 800, a message indicating that communication cannot be performed due to an invalid certificate is displayed. Furthermore, on the first warning screen 800, information indicating that the target (manager or agent) has an invalid certificate and a message prompting the replacement with a valid certificate may also be displayed. It should be noted that, in a case in which the manager 101 and the agent 121 operate on the same host, certificate verification is not performed, and therefore, communication can be performed even if the certificate is invalid. However, the first warning screen 800 is displayed to prompt the replacement of the invalid certificate with a valid certificate. In the example shown in FIG. 4B, the certificate for the Asia server 421, which serves as the agent, is a self-signed certificate, and is therefore an invalid certificate. In this case, “Agent Asia” is displayed on the first warning screen 800 as the warning target,.

In step 704, the certificate management unit 305 determines whether or not any certificates that expire within a predetermined period are present among the certificates that are managed by the manager 101 and the certificate of the agents that are under management. The predetermined period can be set by the user. In this context, as an example, it is assumed that the predetermined period is set as 30 days. In a case in which there is a certificate with a validity period that expires within 30 days, it is determined that a certificate with an expiration date within the specified time period is present, and the processing in S705 is performed. In contrast, in a case in which there are no certificates with a validity period that expires within 30 days, it is determined that no certificate with an expiration date within the specified time period is present, and the processing ends.

In step S705, the display unit 308 displays a second warning screen provided by the certificate management unit 305. FIG. 8B is a diagram illustrating an example of the second warning screen. On a second warning screen 801, a message indicating that the expiration of the validity period of a certificate is approaching is displayed. Furthermore, on the second warning screen 801, information indicating a target (manager or agent) that has a certificate for which the expiration of the validity period is approaching, or a message indicating that communication is not possible after the validity period expires may be displayed. Although, in the example shown in FIG. 4B, the certificate for the American server 412, which is the agent is valid, the expiration of the validity period is approaching. In this case, “Agent America” is displayed on the second warning screen 801 as the warning target.

It should be noted that, although in the example of the flowchart that is shown in FIG. 7, an example is illustrated in which the warning display processing ends after the display of the first warning screen, the present disclosure is not limited thereto. After the first warning screen is displayed, the processing in step S704 may be executed to confirm whether or not there is any certificate for which the expiration of the validity period is approaching, and if a certificate requiring update is found, a second warning screen may be displayed. Additionally, after it is determined that an invalid certificate is present in the processing of S703, the processing of S704 may also be performed. In a case in which both an invalid certificate and a certificate for which the expiration of the validity period is approaching are present, two warnings, a first warning screen and a second warning screen, may also be displayed on one warning screen.

In S707, the certificate management unit 305 determines whether or not an agent that is operating on a host that is different from the host on which the manager 101 operates is present. In a case in which an agent that is operating on a host that is different from the host on which the manager 101 is present, the processing in S708 is performed. In contrast, in a case in which no agent that is operating on a host that is different from the host on which the manager 101 is operating on is present, that is, in a case in which the agents only operate on the same host as the manager 101, there is no risk of impersonation of the connection destination and the like, and therefore, the present processing ends.

In S708, the display unit 308 displays a third warning screen provided by the certificate management unit 305. FIG. 8C shows an example of the third warning screen. In a third warning screen 802, a message indicating that the certificate verification setting is disabled is displayed. Furthermore, in the third warning screen 802, a message indicating the possibility of an adversary-in-the-middle attack and a message prompting the user to enable the verification setting may be displayed.

In a case in which the verification setting is enabled and there is an invalid certificate among the certificates that are managed by the certificate management unit 305, the manager 101 displays a first warning screen (FIG. 8A) for prompting replacement of the invalid certificate. Additionally, in a case in which the verification setting is enabled and there is a certificate that is managed by the certificate management unit 305 for which the validity period will expire within a predetermined period, the manager 101 displays a second warning screen (FIG. 8B) prompting the update of the certificate. In a case in which the verification setting is disabled and an agent operating on a host computer that is different from that on which the manager 101 operates is present, the manager 101 displays a third warning screen (FIG. 8C) for prompting the verification setting to be enabled. The display of these warning screens is performed when an authorized user who can perform certificate verification settings logs in to the service provided by the device management system. By displaying the warning screens, the manager 101 can provide information so that the user can appropriately perform management of certificates and the certificate verification settings.

As explained above, according to the present embodiment, in a case in which self-signed certificates of the manager and the agent are replaced with server certificates issued by a certification authority, it becomes possible to perform certificate verification when performing encrypted communication. When the manager establishes a connection with the agent, in a case in which the server certificate has been registered in the manager, it is determined whether or not to perform certificate verification for the agent according to a verification setting, and if the verification setting is enabled, certificate verification for the agent can be performed. Additionally, when an agent establishes a connection with the manager, in a case in which a server certificate has been registered for the agent, certificate verification for the manager can be performed. As described above, the security of communication within the device management system can be enhanced by enabling verification using the server certificate.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-111668, filed July 11 2024, which is hereby incorporated by reference herein in its entirety.

What is claimed is:

1. A device management system comprising an apparatus that serves as a manager configured to manage a network device and an apparatus that serves as an agent configured to relay communication between the manager and the network device,
the manager comprising:
a memory storing instructions; and
a processor executing the instructions causing the manager to:
set a verification setting indicating whether or not to perform verification of a certificate of the agent when performing encrypted communication with the agent; and
perform verification of a certificate by determining whether or not to perform verification of the certificate of the agent when performing encrypted communication with the agent, based on a certificate registered in the manager and the verification setting, and acquire a certificate from the agent if it is determined to perform verification,
the agent comprising:
a memory storing instructions; and
a processor executing the instructions causing the agent to:
perform verification of a certificate by determining whether or not to perform verification of the certificate of the manager when performing encrypted communication with the manager, based on a certificate registered in the agent, and acquire a certificate from the manager if it is determined to perform verification.

2. The device management system according to claim 1, wherein if the agent that performs communication with the manager operates on the same host computer as the manager, neither the manager nor the agent performs verification of a certificate used for performing encrypted communication.

3. The device management system according to claim 1, wherein the agent does not acquire the verification setting set in the manager, and determines whether or not to perform verification of a certificate of the manager independently of the verification setting.

4. The device management system according to claim 1,
wherein the manager determines to perform verification of a certificate of the agent if a certificate issued by a certificate authority is registered in the manager and the verification setting is enabled, and
wherein the agent determines to perform verification of a certificate of the manager if a certificate issued by a certificate authority is registered in the agent.

5. The device management system according to claim 1,. the agent transmits a certificate to the manager in a case in which a certificate acquisition request is received from the manager, in a case in which a new certificate is registered in the agent, or at a predetermined periodic timing.

6. The device management system according to claim 1, wherein the processor further executes an instruction causing the manager to manage a certificate that is registered in the manager and used for performing encrypted communication and a certificate that is acquired from the agent and used for performing encrypted communication.

7. The device management system according to claim 6,
wherein the manager provides a settings screen configured to receive the verification setting from a user,
wherein the settings screen displays a list of certificates of the manager and the agent managed by the manager, and, if all of the certificates are valid, the manager receives an instruction from a user to enable theverificationsetting.

8. The device management system according to claim 6,
wherein the processor is further configured to execute an instruction causing the manager to:display a warning screen regarding the verification setting and the certificate when a user having authority to perform the verification setting logs in to a service provided by the device management system,wherein in a case in which the verification setting is enabled, and if an invalid certificate is present among certificates managed by the manager, the manager displays a first warning screen prompting replacement of the invalid certificate, and if a certificate having a validation period expiring within a predetermined period is present among the certificates managed by the manager, the manager displays a second warning screen prompting update of the certificate, and wherein in a case in which the verification setting is disabled, and if an agent operating on a host computer that is different from a host computer on which the manager operates is present, the manager displays a third warning screen prompting enabling of the verification setting.

9. The device management system according to claim 1,
wherein the manager performs communication with the agent if it has been determined not to perform verification of a certificate of the agent, and if it is determined, by performing verification of the certificate of the agent, that the certificate is valid, and the manager blocks communication with the agent if it is determined, by performing verification of the certificate of the agent, that the certificate is invalid; and
wherein the agent performs communication with the manager if it has is determined not to perform verification of a certificate of the manager, and if it is determined, by performing verification of the certificate of the manager, that the certificate is valid, and the agent blocks communication with the manager if it is determined, by performing verification of the certificate of the manager, that the certificate is invalid.

10. An apparatus that serves as a manager configured to manage a network device via an agent, the apparatus comprising:
amemory storing instructions; and
a processor executing the instructions causing the manager to:
set a verification setting indicating whether or not to perform verification of a certificate of the agent when performing encrypted communicationwith the agent; and
perform verification of a certificate by determining whether or not to perform verification of the certificate of the agent when performing encrypted communication with the agent, based on a certificate registered in the manager and the verification setting, and acquire a certificate from the agent if it is determined to perform verification.

11. A control method of an apparatus that serves as a manager configured to manage a network device via an agent, the method comprising:
setting a verification setting indicating whether or not to perform verification of a certificate of the agent when performing encrypted communication with the agent; and
determining whether or not to perform verification of the certificate of the agent when performing encrypted communication with the agent, based on a certificate registered in the manager and the verification setting, and
performing verification of a certificate by acquiring a certificate from the agent if it is determined to perform verification of a certificate of the agent.

12. A non-transitory storage medium storing a control program of an apparatus that serves as a manager configured to manage a network device via an agent, causing a computer to perform each step of a controlmethod of the device, the method comprising:
setting a verification setting indicating whether or not to perform verification of a certificate of the agent when performing encrypted communication with the agent;
determining whether or not to perform verification of the certificate of the agent when performing encrypted communication with the agent, based on a certificate registered in the manager and the verification setting, and
performing verification of a certificate by acquiring a certificate from the agent if it is determined to perform verification of a certificate of the agent.
